(19) United States
(12) Patent Application Publication
(10) Pub. No.: US 2018/0071742 A1
(43) Pub. Date: Mar. 15, 2018

(54) JAW CRUSHER SYSTEMS, METHODS, AND APPARATUS

(71) Applicant: Superior Industries, Inc., Morris, MN (US)

(72) Inventors: Lafe Grimm, Hancock, MN (US); Brett Nelson, Hancock, MN (US); Michael Schultz, Troutdale, OR (US)

(21) Appl. No.: 15/702,955

(22) Filed: Sep. 13, 2017

Related U.S. Application Data
(60) Provisional application No. 62/394,191, filed on Sep. 13, 2016.

(51) Int. Cl. B02C 1/04; B02C 25/00; B02C 1/10

(52) U.S. Cl. CPC B02C 1/04; B02C 1/10; B02C 25/00

(57) ABSTRACT

Jaw crusher systems, methods and apparatus are provided. In some embodiments, a tensioning system is provided for resiliently maintaining a force on a toggle plate during operation of a jaw crusher. In some embodiments, one or more jaw die supports are provided for supporting at least one of a movable jaw die and a fixed jaw die.

### BRIEF DESCRIPTION OF THE DRAWINGS

FIG. 1 is a perspective view of an embodiment of a jaw crusher.

FIG. 2 is a side elevation view of the jaw crusher of FIG. 1.

FIG. 3 is a front elevation view of the jaw crusher of FIG. 1.

FIG. 4 is a sectional view of the jaw crusher of FIG. 1 along the section 4-4 of FIG. 3.

FIG. 5 is a partial enlarged view of the jaw crusher of FIG. 1 along the section 4-4 of FIG. 3.

FIG. 6 is a sectional view of the jaw crusher of FIG. 1 along the section 6-6 of FIG. 2.

FIG. 7 is another perspective view of the jaw crusher of FIG. 1.

FIG. 8 is another perspective view of the jaw crusher of FIG. 1.

FIG. 9 is a plan view of the jaw crusher of FIG. 1.

FIG. 10 is a rear elevation view of the jaw crusher of FIG. 1.

FIG. 11 is a perspective view of a moveable jaw of the jaw crusher of FIG. 1.

FIG. 12 is a side elevation view of a moveable jaw of the jaw crusher of FIG. 1.

FIG. 13 is a sectional view of a moveable jaw of the jaw crusher of FIG. 1 along the section 13-13 of FIG. 12.

FIG. 14 is a perspective view of an embodiment of a tensioning cylinder.

FIG. 15 is an exploded view of the tensioning cylinder of FIG. 14.

FIG. 16 is a perspective view of an embodiment of a die support.

FIG. 17 is a side elevation view of the die support of FIG. 16.

FIG. 18 is a perspective view of an embodiment of a jaw die.

FIG. 19 is a side elevation view of the jaw die of FIG. 18.

FIG. 20 is another perspective view of the jaw die of FIG. 18.

FIG. 21 is a perspective view of an embodiment of a jaw die.

FIG. 22 is a side elevation view of the jaw die of FIG. 21.

FIG. 23 is another perspective view of the jaw die of FIG. 21.

FIG. 24 is a perspective view of another embodiment of a die support.

FIG. 25 is a side elevation view of another embodiment of a die support.

FIG. 26 is a side elevation view of another embodiment of a die support.

FIG. 27 is a left side elevation view of an embodiment of a portable crusher plant.

FIG. 28 is a right side elevation view of an embodiment of a tipping grate assembly.

FIG. 29 is a front elevation view of the tipping grate assembly of FIG. 28.

FIG. 30 is a schematic illustration of an embodiment of a hydraulic control system.

FIG. 31 is a schematic illustration of another embodiment of a hydraulic control system.

FIG. 32 is a schematic illustration of an embodiment of a process for controlling a control system.

### DESCRIPTION

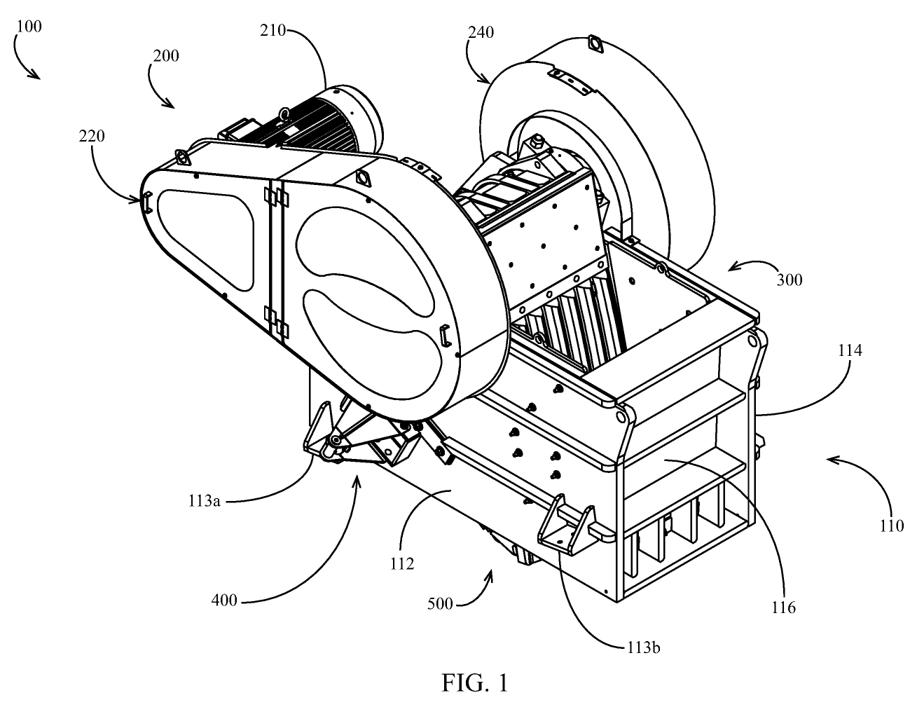

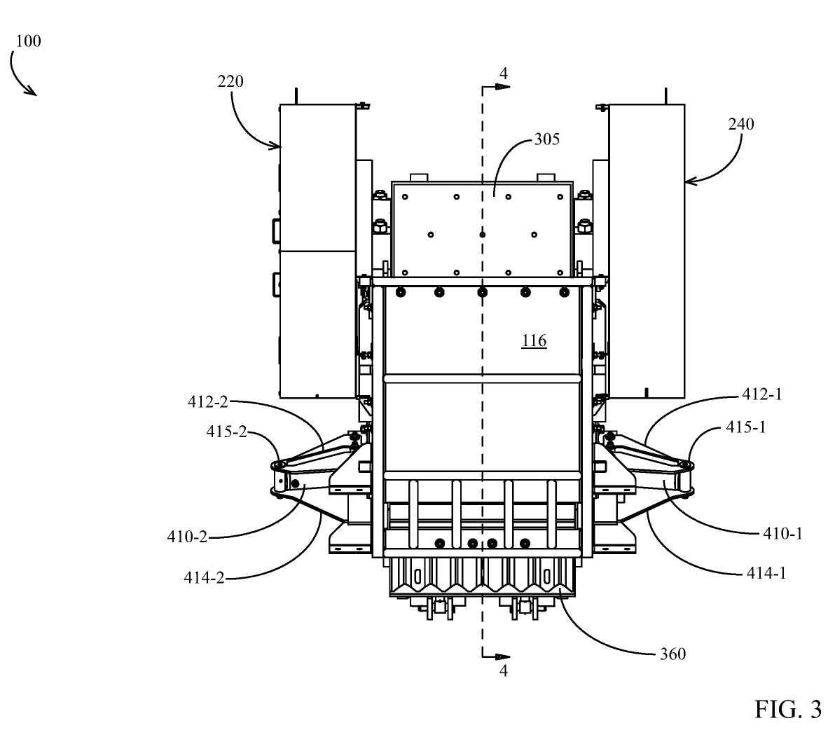

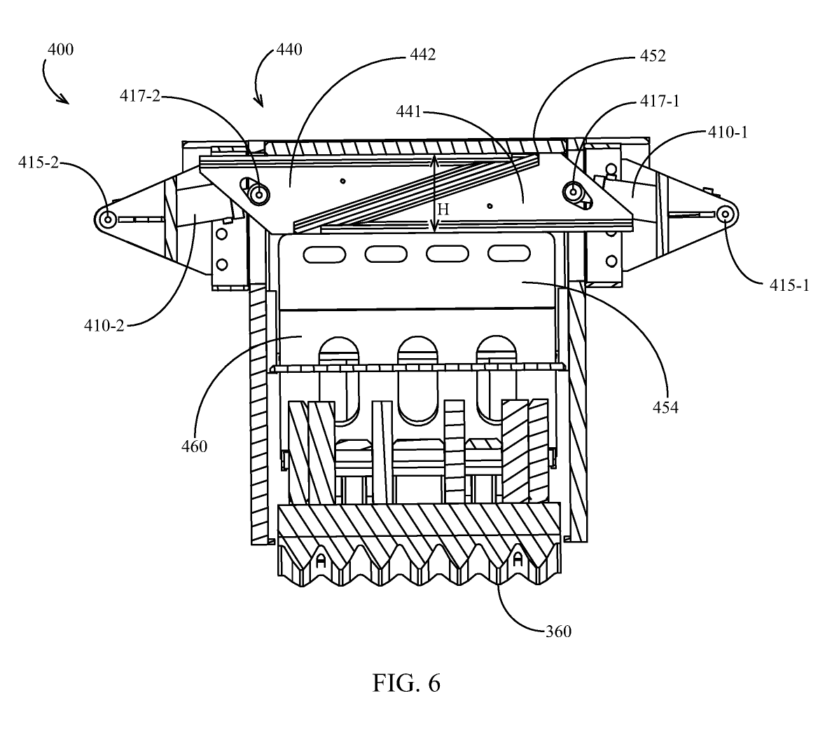

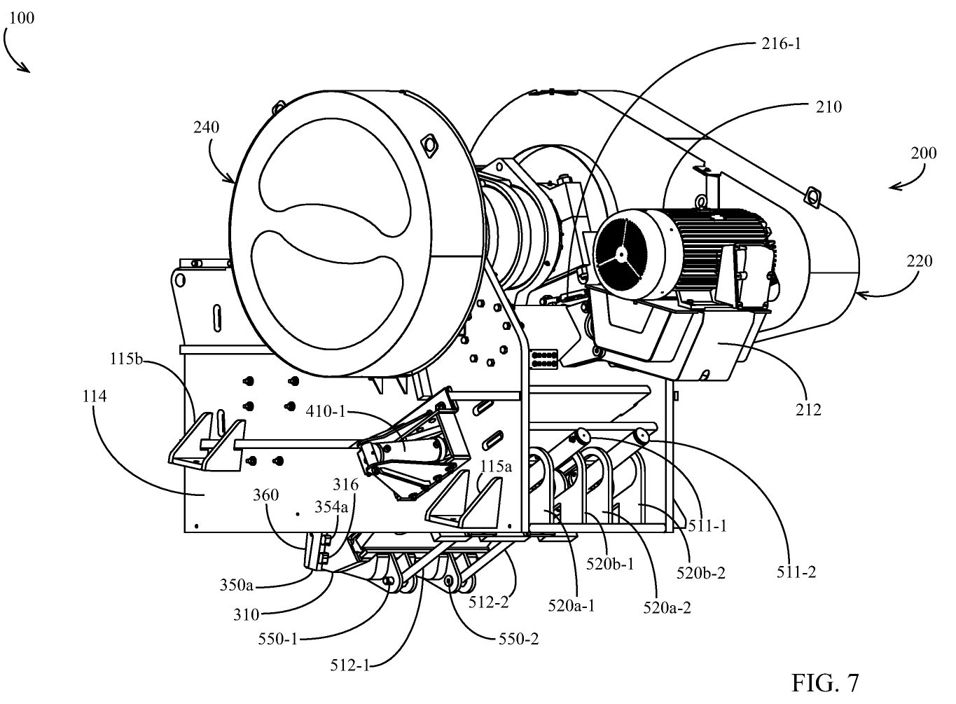

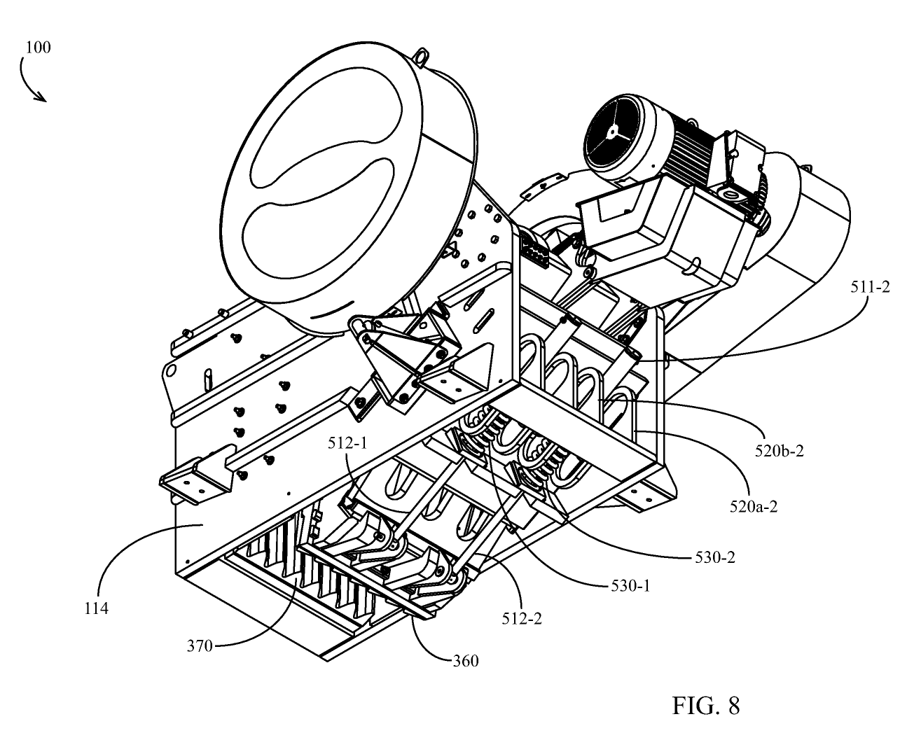

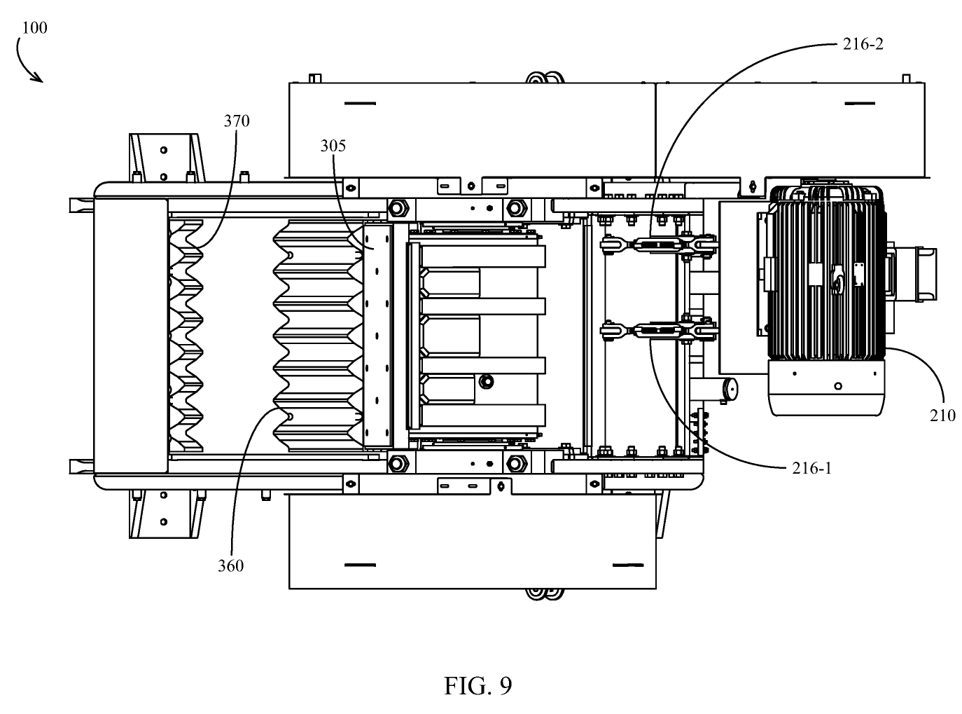

Referring to the drawings, wherein like reference numerals designate identical or corresponding parts throughout the several views, FIGS. 1-10 illustrate an exemplary embodiment of a jaw crusher 100.

In some embodiments, the jaw crusher 100 includes a wall arrangement 110. The wall arrangement 110 optionally includes sidewalls 112 and 114 and a forward wall 116. The wall arrangement 110 optionally includes mounting feet 113 which are optionally mounted to the sidewalls of the wall arrangement. In some embodiments, the mounting feet 113 are optionally disposed to support the wall arrangement 110 on one or more supports (e.g., beams or other structure). In various embodiments, the jaw crusher 100 is mounted to a stationary structure or a mobile support structure (e.g., a track- or wheel-mounted chassis). In some embodiments, the mounting feet 113 are optionally disposed to support the sidewalls 112, 114 such that lower surfaces thereof are optionally disposed an angle relative to a horizontal plane.

In some embodiments, the jaw crusher 100 includes a jaw arrangement 300 which is described more fully herein. The jaw arrangement 300 optionally includes a moveable jaw 310 (which may also be referred to as a pitman). The jaw arrangement 300 optionally includes a fixed jaw 330.

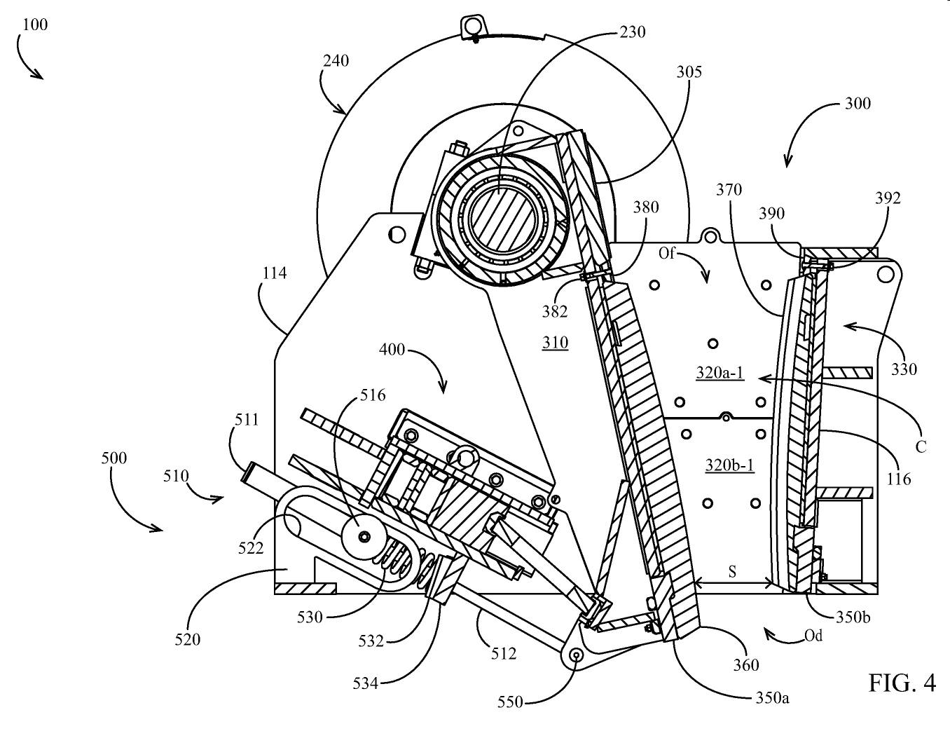

In operation, aggregate material (e.g., rocks, stones, etc.) may be introduced to a feed opening Of disposed at a generally upper end of a crushing chamber C (see FIG. 4). The crushing chamber C is generally located between the moveable jaw 310 and fixed jaw 330. A backing plate 305 is optionally disposed (e.g., at an upper end of the moveable jaw 310) to direct aggregate materials (e.g., materials conveyed toward the crusher generally to the left on the view of FIG. 4) toward the feed opening Of In some embodiments, movement of the moveable jaw 310 crushes (e.g., breaks, comminutes, etc.) the aggregate materials as the aggregate materials descend between the moveable jaw 310 and the fixed jaw 330. Lateral movement of the aggregate materials is optionally limited by contact with the sidewalls 112, 114. An upper cheek plate 320a-1 and/or a lower cheek plate 320b-1 are optionally removably mounted to the sidewall 114. An upper cheek plate 320a-2 and/or a lower cheek plate 320b-2 are optionally removably mounted to the sidewall 114. The aggregate materials optionally exit (e.g., by gravity) the crushing chamber C via discharge opening Od. In some embodiments, the discharge opening Od is disposed between generally lower ends of the moveable and fixed jaws.

A gap size S generally corresponding to a size of the discharge opening Od is shown in FIG. 4. It should be appreciated that although the gap size S is shown as a horizontal measurement, the gap size S may be measured between various points on the fixed jaw 330 and various points on the moveable jaw 310. The gap size S may vary as the moveable jaw 310 moves generally toward and away from the fixed jaw 330. A minimum value of the gap size S (which minimum value may be referred to as a closed-side setting of the jaw arrangement) may be measured when the lower portion of moveable jaw 310 is closest to the lower portion of fixed jaw 330.

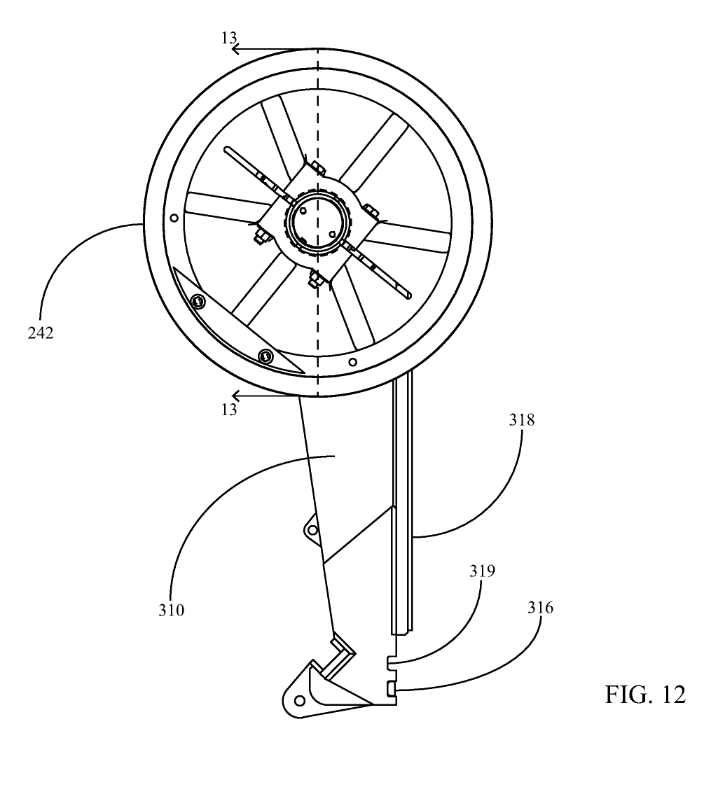

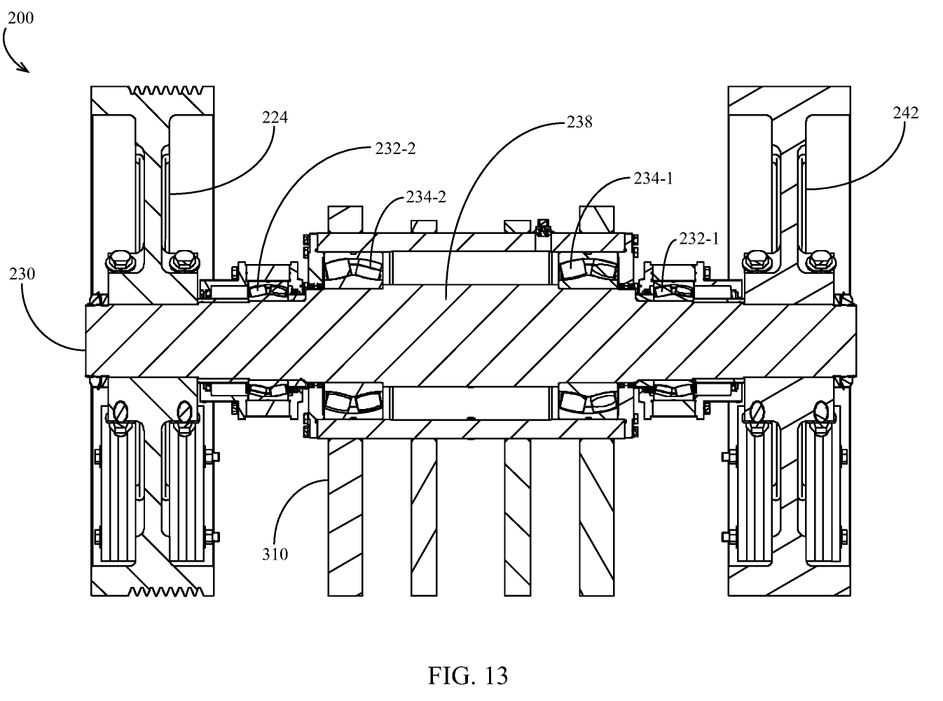

Referring to FIGS. 1 and 13, in some embodiments, the jaw crusher 100 includes a drive system 200 which optionally moves the moveable jaw 310. The drive system 200 optionally moves the moveable jaw 310 repetitively along a path in which the moveable jaw moves alternately toward and away from the fixed jaw 330. The drive system 200 is optionally supported by the sidewalls 112, 114. The drive system 200 optionally includes a motor 210 (e.g., an electric motor or other suitable motor). The motor 210 optionally drives an input assembly 220 optionally including a flywheel 224. The input assembly 220 optionally includes a sheave and v-belt (not shown) configured to drive the flywheel 224. The drive system 200 optionally includes a shaft 230 (e.g., an eccentric shaft). The shaft 230 is optionally driven for rotation by the flywheel 224. The shaft 230 optionally drives a flywheel 242 (e.g., at least partially within a housing 240) which is optionally disposed on an opposing end of the shaft 230 from the flywheel 224. The shaft 230 is optionally rotatably supported by bearings 232-1, 232-2 or other suitable apparatus. The shaft 230 (e.g., an eccentric portion 238 thereof) optionally rotatably supports the moveable jaw 310 (e.g., by bearings 234-1, 234-2 or other suitable apparatus). In some embodiments (including some in which the shaft 230 includes an eccentric portion 238) an upper portion of the moveable jaw 310 is optionally moved along a path such as a repetitive (e.g., rotational, translational, circular, elliptical, oblong, curvilinear, etc.) path. In some embodiments a generally upper portion of the moveable jaw rotates generally clockwise on the view of FIG. 4.

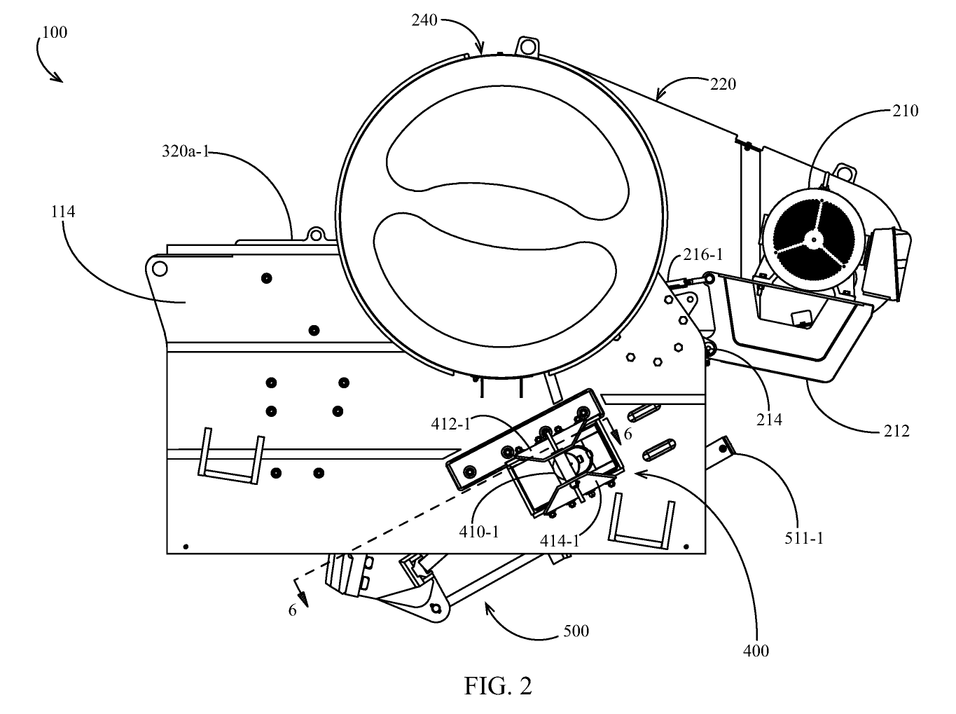

Referring to FIGS. 2, 7 and 9, the motor 210 is optionally mounted on a platform 212. In some embodiments, the platform 212 is pivotally coupled (e.g., about a pivot 214) to a wall or other support structure of the jaw crusher. In some embodiments, the pivotal position of platform 212 is optionally adjustable, e.g., by adjusting a length of one or more turnbuckles 216 operably coupled to and supporting the platform 212.

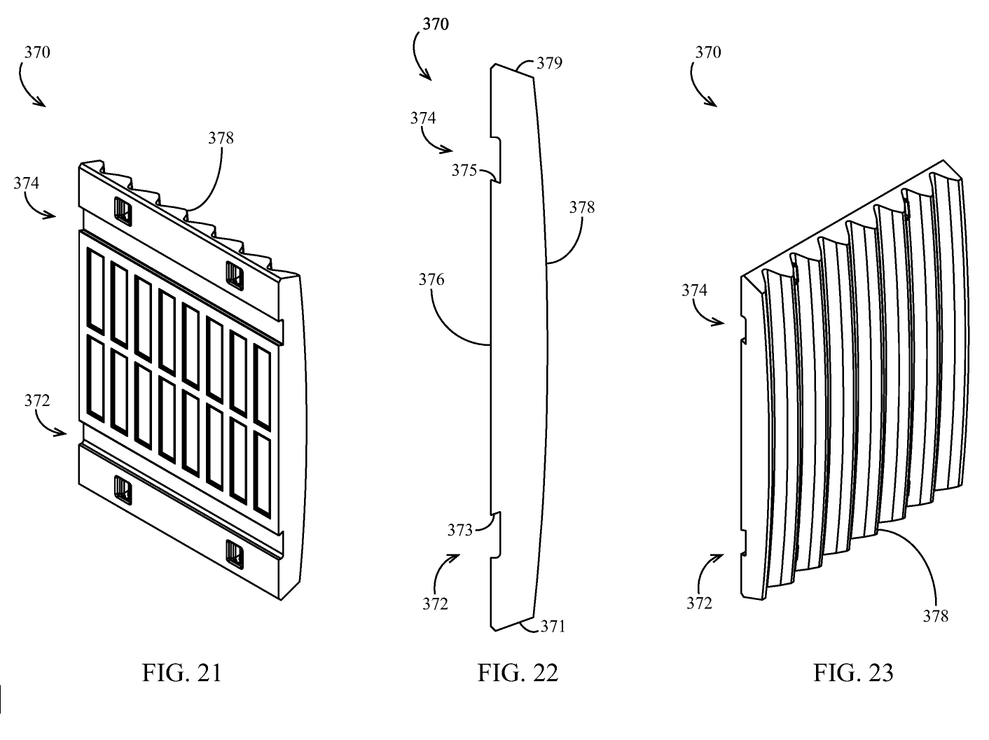

Referring to FIG. 4 and FIGS. 21-23, the fixed jaw 330 optionally includes a jaw die 370 (e.g., made of manganese steel or another steel or other suitable material optionally having relatively high abrasion resistance and/or impact strength). The jaw die 370 is optionally removably mounted to the remainder of the fixed jaw 330. The jaw die 370 is optionally supported (e.g., indirectly or directly) by the forward wall 116.

In some embodiments, the jaw die 370 is optionally supportable in a first orientation and a second orientation; for example, a first orientation and a second orientation generally inverted (e.g., generally vertically inverted) from the second orientation.

In some embodiments, the jaw die 370 optionally includes an uneven (e.g., ridged, fluted, grooved, corrugated, etc.) surface 378. The uneven surface 378 is optionally oriented to face the crushing chamber C (e.g., in both the first and second orientations of the jaw die 370).

The jaw die 370 optionally includes a channel 372 (or other suitable structure or opening) configured to support the jaw die (e.g., in the first orientation). The channel 372 optionally includes an angled upper surface 373 (e.g., a surface extending generally downwardly and generally toward the forward wall 116 in the first orientation). Die channels described herein may comprise slots, grooves, notches, or have other shapes or configurations which may be symmetrical or asymmetrical; the die channels may extend partially or fully across the width of the die in various embodiments.

### Die Support Embodiments

A support 350b (e.g., a transversely extending bar or other suitable structure) is optionally disposed adjacent to the jaw die 370 and optionally configured to support the jaw die 370. The support 350b is optionally disposed at a lower end of the jaw die 370 (e.g., in the first orientation). The support 350b optionally engages the channel 372 to support the jaw die 370. The support 350b optionally includes an angled upper surface 355 (e.g., extending generally upwardly and away from the forward wall 116). The angled upper surface 355 optionally releasably engages the surface 373 of channel 372, thus optionally retaining the jaw die 370 in position (e.g., relative to the forward wall 116).

A retainer 390 (e.g., a wedge or other suitable structure) optionally retains the jaw die 370 in position (e.g., relative to the forward wall 116). The retainer 390 is optionally removably mounted to the forward wall 116 (or other structure) by a removable fastener 392 (e.g., a bolt-and-nut assembly). The retainer 390 optionally engages a surface (e.g., an upper surface) of the jaw die 370. For example, in the first orientation the retainer 390 optionally engages a surface 379 of the jaw die 370.

In a maintenance mode, the retainer 390 is optionally removable to allow the jaw die 370 to be displaced (e.g., upwardly) in order to disengage the jaw die 370 from the support 350b. Once disengaged, the jaw die 370 may be removed, replaced or in some embodiments reoriented.

It should be appreciated that supportability of the jaw die 370 in first and second orientations is optional; however, in some embodiments additional and optional support features described below are for supporting the jaw die 370 in the second orientation. A surface 371 optionally engages the retainer 390 in the second orientation. The surface 371 is optionally generally oppositely oriented relative to the surface 371. A channel 374 optionally engages the support 350b in the second orientation. The channel 374 optionally includes an angled surface 375 which is optionally releasably engaged by the angled upper surface 355 of the support 350b. The angled surface 375 is optionally generally oppositely oriented relative to the angled surface 373.

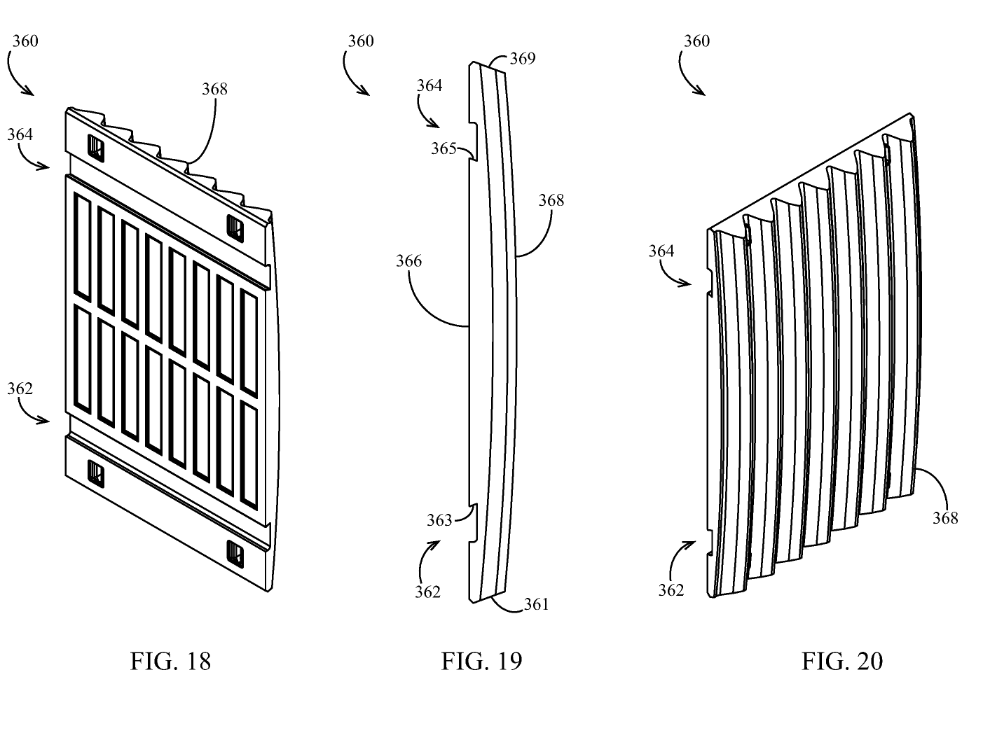

Referring to FIG. 4 and FIGS. 18-20, the moveable jaw 310 optionally includes a jaw die 360 (e.g., made of manganese steel or another steel or other suitable material optionally having relatively high abrasion resistance and/or impact strength). The jaw die 360 is optionally retained against one or more forward surfaces 318 of the moveable jaw 310. The jaw die 360 is optionally removably mounted to the remainder of the moveable jaw 310. The jaw die 360 is optionally supported (e.g., indirectly or directly) by remainder of the moveable jaw 310.

In some embodiments, the jaw die 360 is optionally supportable in a first orientation and a second orientation; for example, a first orientation and a second orientation generally inverted (e.g., generally vertically inverted) from the second orientation.

In some embodiments, the jaw die 360 optionally includes an uneven (e.g., ridged, fluted, grooved, corrugated, etc.) surface 368. The uneven surface 368 is optionally oriented to face the crushing chamber C (e.g., in both the first and second orientations of the jaw die 360.

The jaw die 360 optionally includes a channel 362 (or other suitable structure) configured to support the jaw die (e.g., in the first orientation). The channel 362 optionally includes an angled upper surface 363 (e.g., a surface extending generally downwardly and generally away from the forward wall 116 in the first orientation).

A support 350a (e.g., a transversely extending bar or other suitable structure) is optionally disposed adjacent to the jaw die 360 and optionally configured to support the jaw die 360. The support 350a is optionally disposed at a lower end of the jaw die 360 (e.g., in the first orientation). The support 350a optionally engages the channel 362 to support the jaw die 360. The support 350a optionally includes an angled upper surface 355 (e.g., extending generally upwardly and toward the forward wall 116) of the support 350a. The angled upper surface 355 optionally releasably engages the surface 363 of channel 362, thus optionally retaining the jaw die 360 in position (e.g., relative to the remainder of the moveable jaw 310).

A retainer 380 (e.g., a wedge or other suitable structure) optionally retains the jaw die 360 in position (e.g., relative to the remainder of the moveable jaw 310). The retainer 380 is optionally removably mounted to the remainder of the moveable jaw 310 (or other structure) by a removable fastener 382 (e.g., a bolt- and-nut assembly). The retainer 380 optionally engages a surface (e.g., an upper surface) of the jaw die 360. For example, in the first orientation the retainer 380 optionally engages a surface 369 of the jaw die 360.

In a maintenance mode, the retainer 380 is optionally removable to allow the jaw die 360 to be displaced (e.g., upwardly) in order to disengage the jaw die 360 from the support 350a. Once disengaged, the jaw die 360 may be removed, replaced or in some embodiments reoriented.

It should be appreciated that supportability of the jaw die 360 in first and second orientations is optional; however, in some embodiments additional and optional support features described below are for supporting the jaw die 360 in the second orientation. A surface 361 optionally engages the retainer 380 in the second orientation. The surface 361 is optionally generally oppositely oriented relative to the surface 361. A channel 364 optionally engages the support 350a in the second orientation. The channel 364 optionally includes an angled surface 365 which is optionally releasably engaged by the angled upper surface 355 of the support 350a. The angled surface 365 is optionally generally oppositely oriented relative to the angled surface 363.

In some embodiments, the supports 350a and 350b are substantially similar and/or equivalent structure. In some embodiments, the supports 350a and 350b have different features and/or shape.

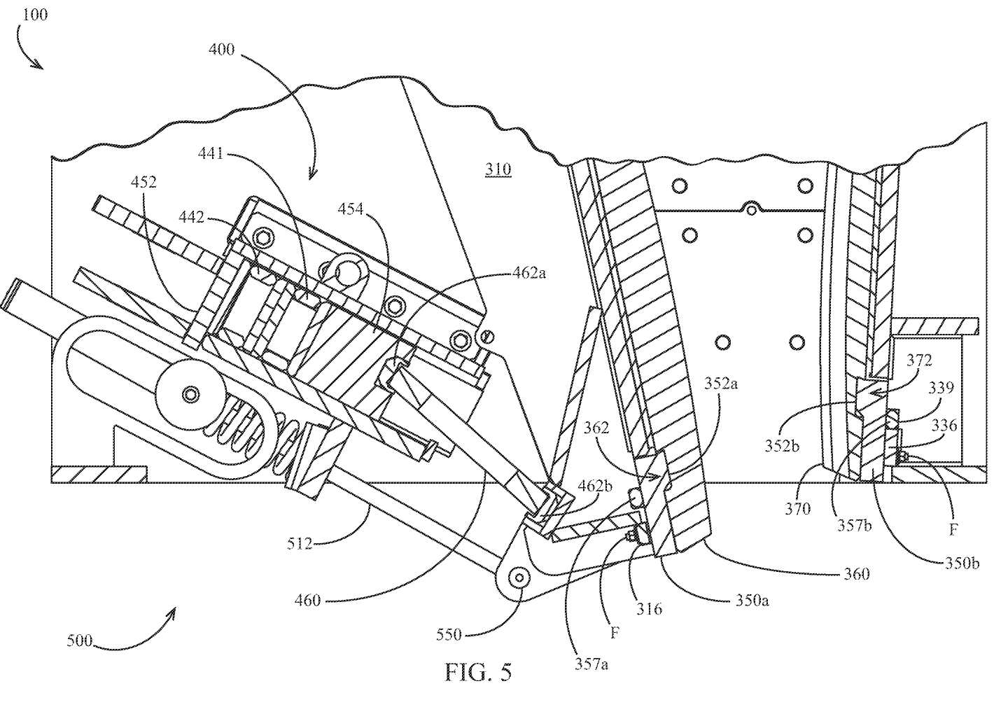

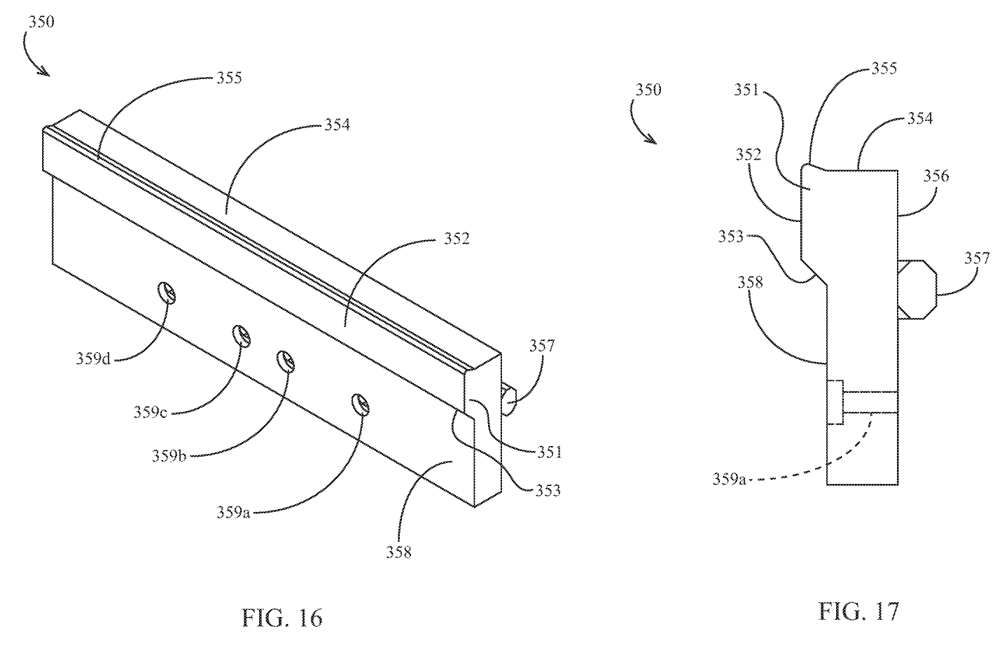

Referring to FIGS. 5, 16, and 17, an exemplary embodiment of a support 350 (e.g., the support 350a and/or support 350b) is illustrated. The support 350 optionally includes an angled upper surface 355 (which may be referred to as a support surface) as described herein. The upper surface 355 may also be parallel to upper surface 354. The optionally angled upper surface 355 and/or the upper surface 354 optionally engage the associated jaw die and optionally support at least a portion of the weight of the associated jaw die. The angled upper surface 355 optionally extends from the upper surface 354 to a surface 352. The surface 352 is optionally at least partially disposed inside the associated jaw die (e.g., inside channel 362 and/or channel 372). The support surface 355 optionally comprises a surface of a protrusion 351. The protrusion 351 optionally extends laterally at least partially across a width of the support 350. The protrusion 351 optionally includes a lower surface 353. The surface 352 optionally comprises a surface of the protrusion 351. The protrusion 351 optionally extends at least partially into the associated jaw die (e.g., a channel or other cavity thereof). The surfaces 352 and 355 are optionally disposed upwardly from (e.g., above) a lower (e.g., lowermost) end of the associated jaw die.

The support 350 is optionally removably mounted to the associated jaw die, e.g., by one or more fasteners F such as a nut-and-bolt assembly. The fasteners F may be inserted through one or more openings 359 in the support 350. The openings 359 may extend through a lower surface 358 and a surface 356.

In some embodiments, the support 350a is optionally removably mounted (e.g., by fasteners F) to an attachment bar 316 optionally mounted to or otherwise comprised in the moveable jaw 310. The attachment bar 316 optionally comprises a transversely extending bar. The attachment bar 316 optionally includes one or more openings 317 for attachment of fasteners F.

In some embodiments, the support 350b is optionally removably mounted (e.g., by a fasteners F) to an attachment bar 336 optionally mounted to or otherwise comprised in the fixed jaw 330. The attachment bar 336 optionally comprises a transversely extending bar. The attachment bar 336 optionally includes one or more openings (not shown) for attachment of fasteners F.

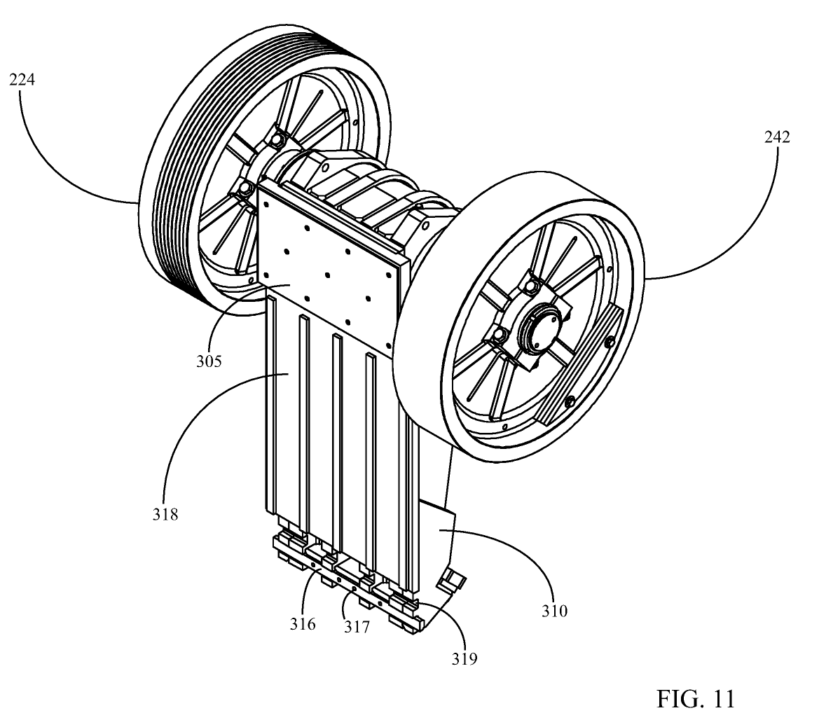

In some embodiments, a protrusion 357 optionally extends from each support 350 (e.g., from the surface 356 as illustrated). The protrusion 357 may be formed as a part with or mounted (e.g., by welding) to the surface 356. The protrusion 357 optionally extends transversely at least partially along the surface 356. The protrusion 357 of each support 350 optionally extends into one or more or notches (e.g., rectangular notches, channels) in the associated jaw. For example, the protrusion 357b of the support 350b optionally extends into one or more notches 339 (see. FIGS. 11-12) in the fixed jaw 330. Similarly, the protrusion 357a of the support 350a optionally extends into one or more notches 319 in the moveable jaw 310. Each notch 319, 339 optionally includes an upper surface which contacts the associated protrusion 357 (e.g., to impose a downward force on the protrusion 357 and prevent upward movement of the support relative to the associated jaw). Each notch 319, 339 optionally includes a lower surface which contacts the associated protrusion 357 (e.g., to impose an upward force on the protrusion 357 and prevent downward movement of the support relative to the associated jaw). In alternative embodiments, a protrusion (e.g., laterally extending protrusion) may be mounted to one or more jaws and optionally extend into one or more notches formed in the associated support 350.

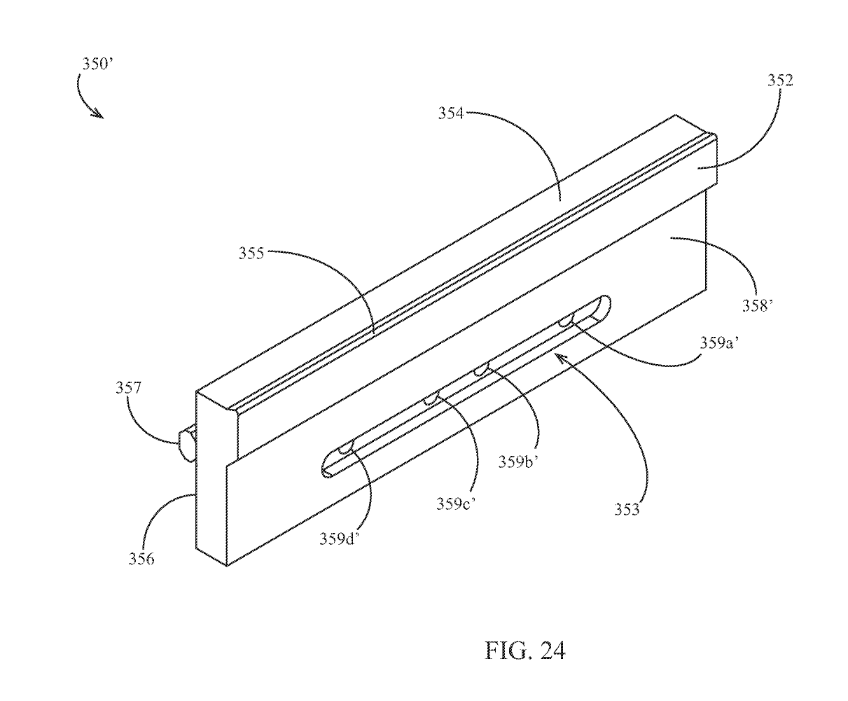

Referring to FIG. 24, an alternative embodiment of a support 350′ is illustrated. The support 350′ optionally comprises one or more indentations 353 which surrounds one or more openings in the support (e.g., opening 359a′, 359b′, 359c′, 359d′). Indentation 353 is optionally formed in a surface 358′ of the support. In some embodiments, the indentation 353 comprises an elongated groove as illustrated; in other embodiments, individual indentations surround (e.g., are centered on) each of one or more openings 359a′, 359b′, 359c′, 359d′. Indentation 353 optionally accommodates at least a portion of a bolt head (e.g., bolt head, square bolt head, etc.) such that the head of a bolt inserted into one of the openings does not extend axially past surface 358′. In some embodiments, a height and/or width of indentation 353 is sufficiently large to permit tightening of a bolt head with a tool inserted at least partially into the indentation 353.

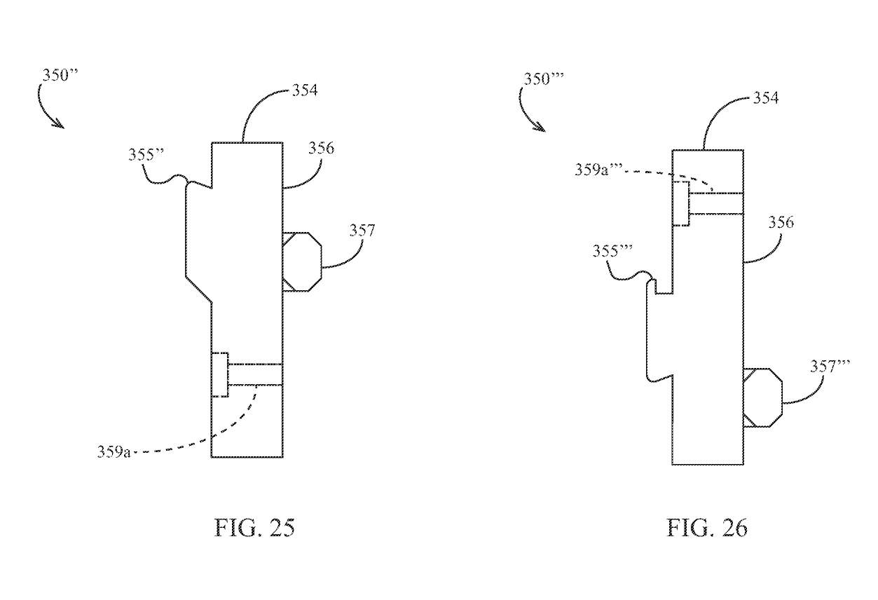

Referring to FIG. 25, another exemplary embodiment of a support 350″ is illustrated. The support 350″ optionally includes a modified upper surface 355″ disposed at least partially lower than the upper surface 354.

Referring to FIG. 26, another exemplary embodiment of a support 350′″ is illustrated. The support 350′″ optionally includes a modified upper surface 355′″ having a modified side profile. The modified upper surface 355′″ is optionally disposed below one or more of openings 359′″. The support 350′″ optionally includes a protrusion 357′″ disposed at least partially below one or more of the openings 359′″ and/or upper surface 355′″.

The various embodiments of supports described herein may be used with various jaw crusher embodiments. For example, the supports (or modified embodiments thereof) may be used with the jaw crushers disclosed in U.S. Pat. Nos. 5,857,630; 4,361,289; and/or 5,772,135; the entire disclosures of which are hereby incorporated by reference herein.

### Gap Adjustment System Embodiments

Referring to FIGS. 2 through 6, in some embodiments the jaw crusher 100 includes a gap adjustment system 400 for adjusting a gap (e.g., a minimum value of the gap S) between the fixed jaw 330 and moveable jaw 310.

In the illustrated embodiment, the gap adjustment system 400 optionally comprises a pair of actuators 410-1, 410-2 (e.g., hydraulic actuators) supported at each sidewall of the jaw crusher. Each actuator 410 is optionally pivotally supported at a first end at a pivot 415 (e.g., pin). The pivots 415 are optionally disposed outboard of the sidewalls of the jaw crusher. Each pivot 415 is optionally supported by one or more supports 412, 414. The supports 412, 414 are optionally mounted to a sidewall of the jaw crusher and optionally extend outboard of the sidewalls of the jaw crusher. Each actuator 410-1, 410-2 is optionally supported at a second end at a pivot 417.

Extension and/or retraction of the actuator 410-1 and/or actuator 410-2 optionally modifies a gap (e.g., a minimum value of the gap S) between the fixed and moveable jaws. In the illustrated embodiment, extension and/or retraction of one or more actuators 410 optionally modifies a height H of a wedge assembly 440. The wedge assembly 440 optionally includes a first wedge 441 optionally pivotally connected to the actuator 410-1. The first wedge 441 optionally has an angled surface which slidingly contacts an angled surface of a second wedge 442. The second wedge 442 is optionally pivotally connected to the actuator 410-2. As the actuators 410 extend to move the wedges 441, 442 inboard, the height H of wedge assembly 440 optionally increases. As the actuators 410 retract to move the wedges outboard, the height H of wedge assembly 440 optionally decreases. The actuators 410-1, 410-2 are optionally constrained (e.g., by a flow divider or other fluid control device) to extend and retract synchronously, e.g., such that wedges 441, 442 move inboard and outboard by equal or approximately equal increments.

The height H of wedge assembly 440 optionally corresponds to a spacing between a backing surface 452 and a toggle block 454. The toggle block 454 optionally supports a first toggle seat 462a. A second toggle seat 462b is optionally supported on a lower portion of the moveable jaw 310. A toggle plate 460 is optionally supported at a first end by the toggle block 462 and at a second end by the moveable jaw 310. The toggle plate 460 is optionally seated in the first and second toggle seats 462 as illustrated. As the height H of the wedge assembly 440 increases or decreases, the toggle plate 460 is advanced such that the minimum value of gap S decreases or increases, respectively. The toggle plate 460 is optionally retained in position by a tensioning assembly 500 (described further herein) while allowing the lower portion of the moveable jaw to move up and down (e.g., with eccentric movement of the upper portion of the moveable jaw). The toggle plate 460 optionally has a strength selected to allow the toggle plate to break if an unacceptably hard and/or uncrushable object (e.g., tramp iron) is compressed between the moveable and fixed jaws.

### Tensioning System Embodiments

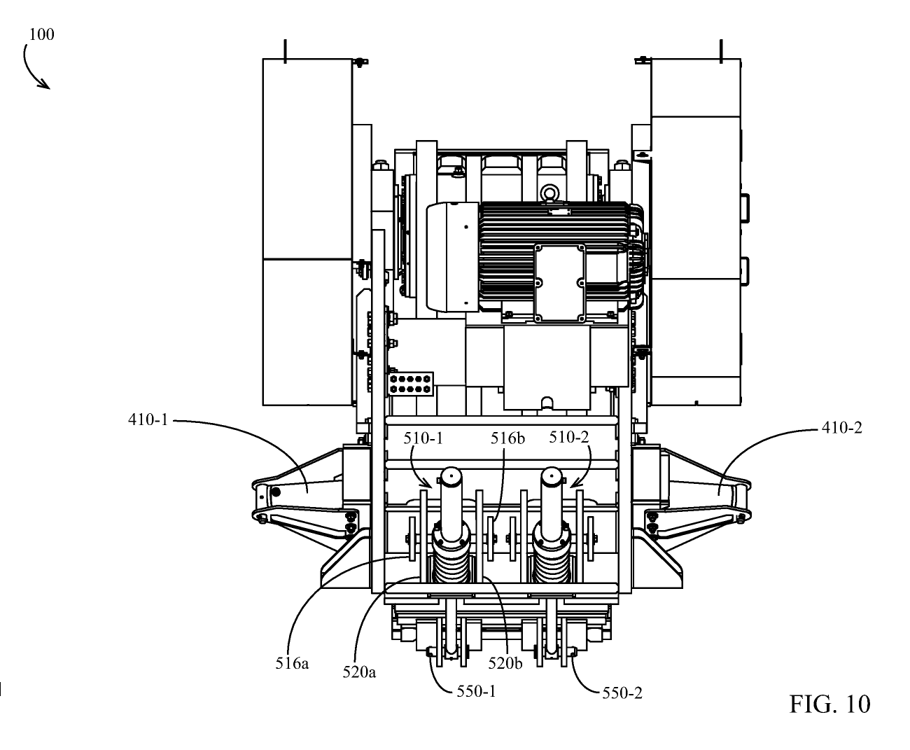

Referring to FIGS. 4 and 10, a tensioning system 500 optionally resiliently retains the toggle plate 460. The tensioning system 500 optionally includes one or more tensioning apparatus 510; in the illustrated embodiment, a first tensioning apparatus 510-1 and second tensioning apparatus 510-2 are disposed in generally side-by-side relation.

Each tensioning apparatus 510 optionally comprises an actuator 502 (e.g., a hydraulic actuator) comprising a cylinder 511 and rod 512. The rod 512 is optionally pivotally coupled to the moveable jaw 310 (e.g., at a lower end thereof) by a pivot 550 (e.g., a pin). The tensioning apparatus 510 optionally comprises a spring 530 (e.g., a compression spring) optionally held in place between the cylinder 511 and a collar 532. The collar 532 is optionally supported on a support 534. Each of collar 532 and support 534 optionally has an opening (not shown) which are aligned to receive the rod 512 therethrough. The compressive force on the spring 530 optionally supports the cylinder 511.

In alternative embodiments, the tensioning apparatus may comprise additional or alternative suitable apparatus including an accumulator (e.g., in fluid communication with cylinder 511) and/or air chamber (e.g., in a rod end of the cylinder 511). In alternative embodiments, the tensioning apparatus may be supported at its rearward end rather than at a medial location. In alternative embodiments, the spring 530 (or other biasing apparatus) may be disposed in differing locations relative to the cylinder 511, e.g., rearward of the cylinder 511 or adjacent to the pivot 550. In alternative embodiments, the tensioning apparatus may comprise a pneumatic cylinder and/or air spring. In alternative embodiments, the tensioning apparatus is configured such that the spring 530 is in tension rather than in compression.

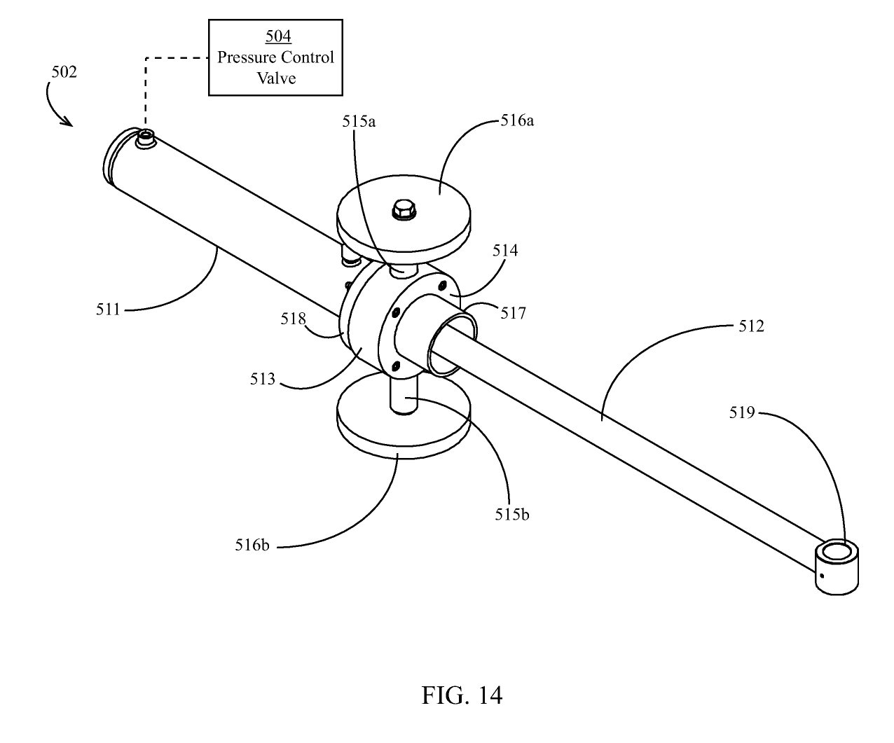

In operation, a pressure in the cylinder 511 (e.g., in a head end chamber thereof) modifies the compression of spring 530. In some embodiments, the pressure is controlled by a pressure control valve 504 (e.g., a pressure reducing-relieving valve) in fluid communication with the cylinder 511 (e.g., with a head end chamber thereof). A pressure control valve 504 is illustrated schematically in FIG. 14. The pressure control valve 504 is optionally configured to maintain any one of a range of selected pressures in the cylinder 511, thus maintaining a first threshold-range force (e.g., a constant force or a force within an operationally acceptable variation such as +/−5%, +/−10%, or +/−30% of a nominal value) on the spring 530 even as the spring extension varies during operation of the moveable jaw 310. Thus a second threshold-range force (e.g., a constant force or a force within an operationally acceptable variation such as +/−5%, +/−10%, or +/−30% of a nominal value) on the toggle plate 460.

In some embodiments, one or more guards 520 are optionally disposed to prevent all or a portion of the tensioning apparatus 510 from being ejected from the jaw crusher (e.g., in the case of a failure of the pivot 550, a failure of the rod 512, or other component failure). The guards 520 are optionally disposed in generally side-by-side relation with the tensioning apparatus (e.g., on the rear view of FIG. 10). One or more guards 520 are optionally disposed between two tensioning apparatus 510. One or more tensioning apparatus 510 are optionally disposed between two guards 520.

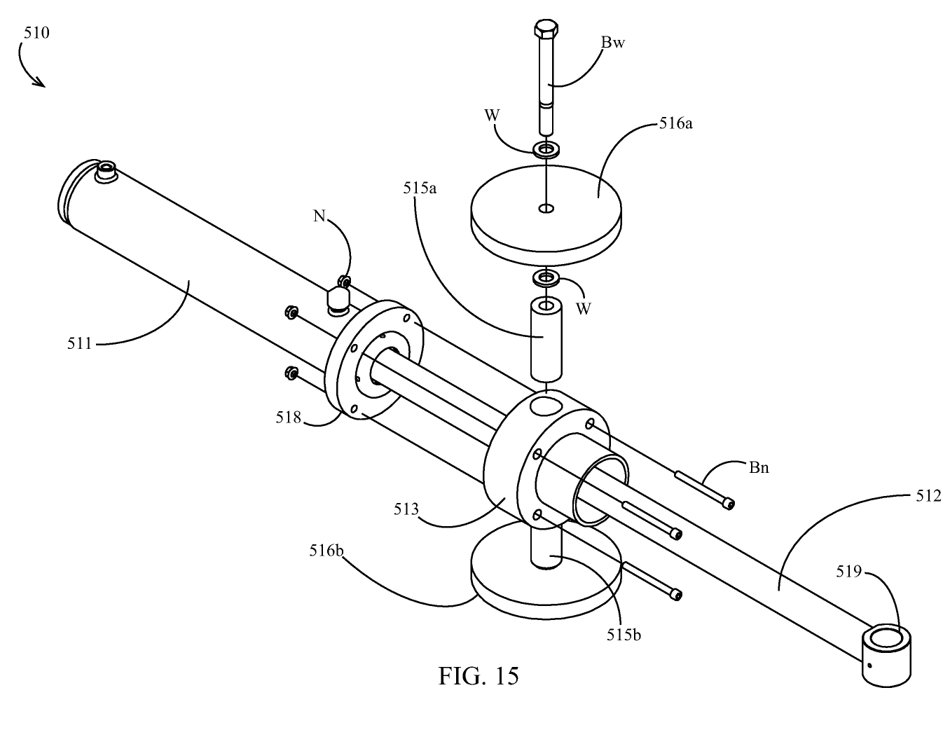

Referring to FIGS. 14 and 15, the actuator 502 of the tensioning apparatus is shown in more detail. The spring 530 optionally contacts an axial surface 514 on a collar 513. The collar 513 is optionally mounted to an annular rim of the cylinder 511 (e.g., by bolts Bn and nuts N as illustrated, or by other suitable fasteners). A cylindrical portion 517 optionally extends inside the spring 530 and is mounted to or formed as a part with the collar 513. The rod 512 is optionally coupled to the pivot 550 at an opening 519 which is optionally provided at an end of the rod 512.

In some embodiments, one or more rods 515 extend from the tensioning apparatus 510 through an opening 522 in an associated guard 520. The opening 522 is optionally shaped to allow a range of motion of the tensioning apparatus without interference; however, a rearward end of the opening 522 is optionally positioned to prevent ejection of all or a portion of the tensioning apparatus 510 by contact with the rod 515. In some embodiments, a guard such as a disc 516 or other structure is mounted to the rod 515 on an opposite side of the opening 522 from the cylinder 511; the disc 516 optionally has a dimension (e.g., height) greater than that of the opening 522 and thus optionally prevents the rod 515 from withdrawing from the opening 522. Each rod 515 and/or disc 516 is optionally removably retained to the collar 513 by a fastener such as a bolt Bw; washers W may be disposed between the bolt Bw and the disc 516 and between the disc 516 and the rod 515.

In some embodiments, a cover is mounted to a rearward end of the jaw crusher 100 as an alternative or additional protection to the guard or guards 520.

### Plant Embodiments

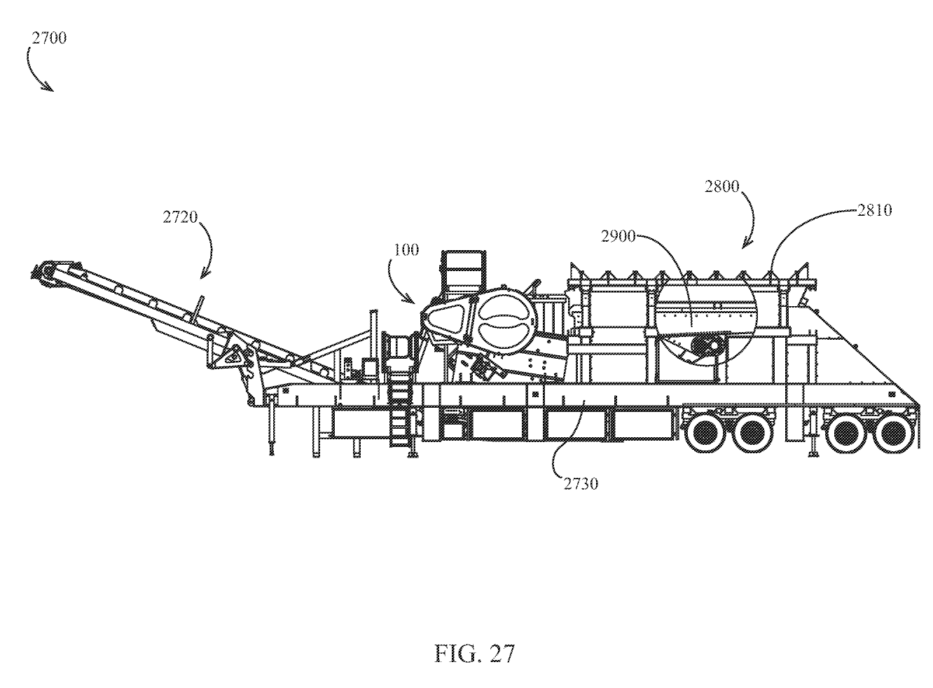

Referring to FIGS. 27 through 29, an embodiment of a crushing plant 2700 incorporating an embodiment of jaw crusher 100 is illustrated. In the illustrated embodiment, the plant 2700 is supported on a wheeled frame 2730; in other embodiments, the plant may be supported on tracks, skids or other structures and may be either stationary or portable. The plant 2700 optionally includes a feeder 2900 (e.g., a vibratory feeder such as a grizzly feeder) disposed to transfer (e.g., by gravity or by conveyor apparatus) a subset of input material to the jaw crusher 100 (e.g., a feed inlet thereof). A tipping grate assembly 2800 is optionally disposed to receive aggregate material thereon and prevent oversize material to fall through a grate 2810 thereof onto the feeder 2900.

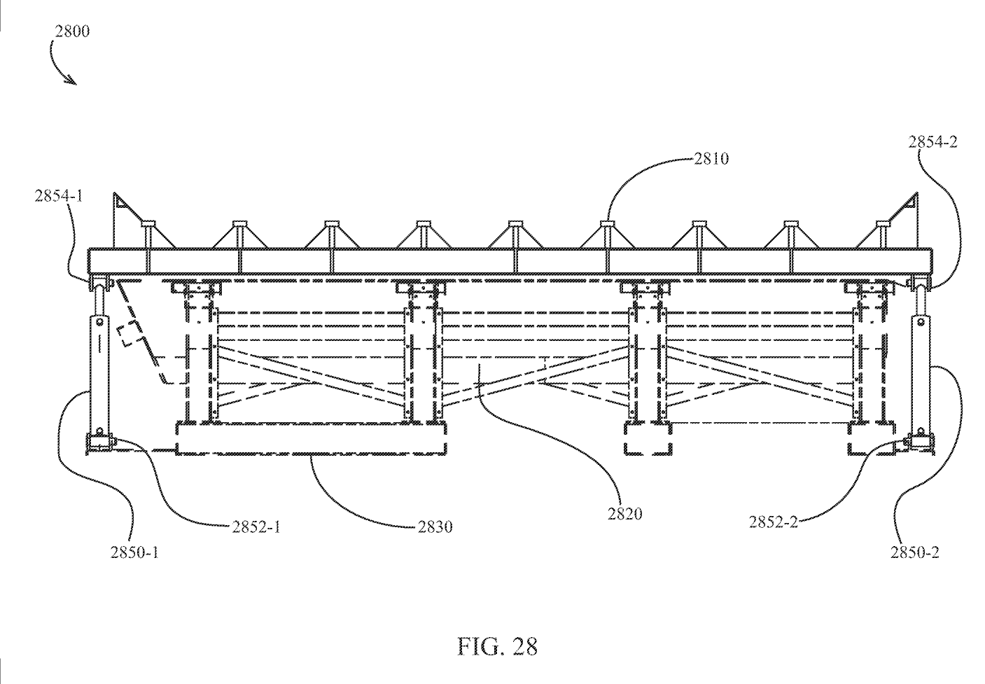

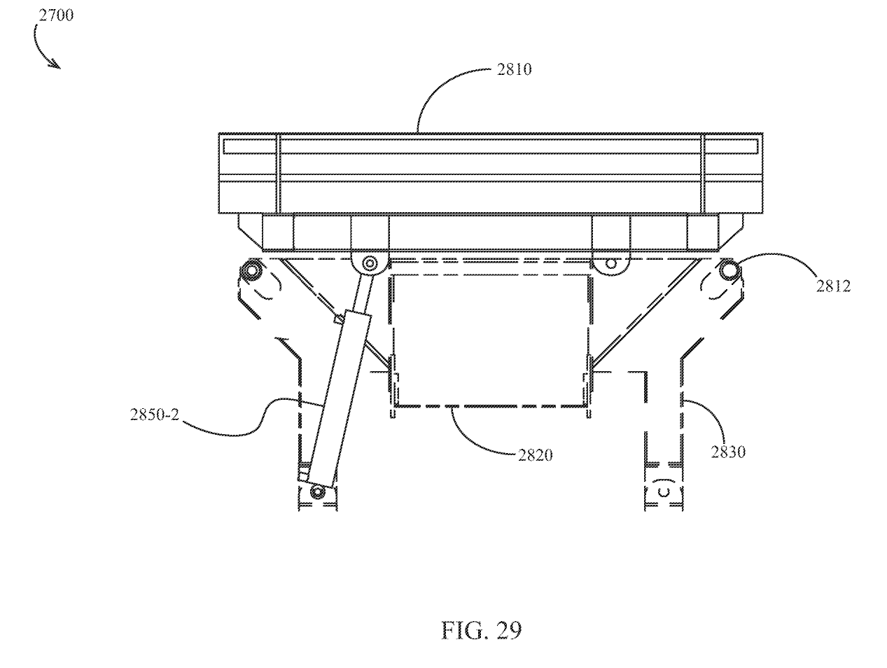

Referring to FIGS. 28 and 29, the grate 2810 is optionally pivotally supported on frame 2830 (e.g., by one or more generally horizontal pivots 2812). One or more actuators 2850 (e.g., two actuators 2850-1, 2850-2) are optionally pivotally coupled to the frame 2830 and to the grate 2810 (e.g., at pivots 2852, 2854 respectively). Extension of actuators 2850 optionally selectively modifies a position of the grate 2810 (e.g., selectively tips the grate) such that oversize material falls off the grate.

It should be appreciated that the various jaw crusher and/or hydraulic control system embodiments described herein may be employed in other portable or stationary plant contexts with different equipment and/or processing steps, and may also be used in self-standing implementations or other contexts. The plant embodiments described herein, and various equipment described in relation to those plant embodiments, are merely illustrative examples.

### Hydraulic Control System Embodiments

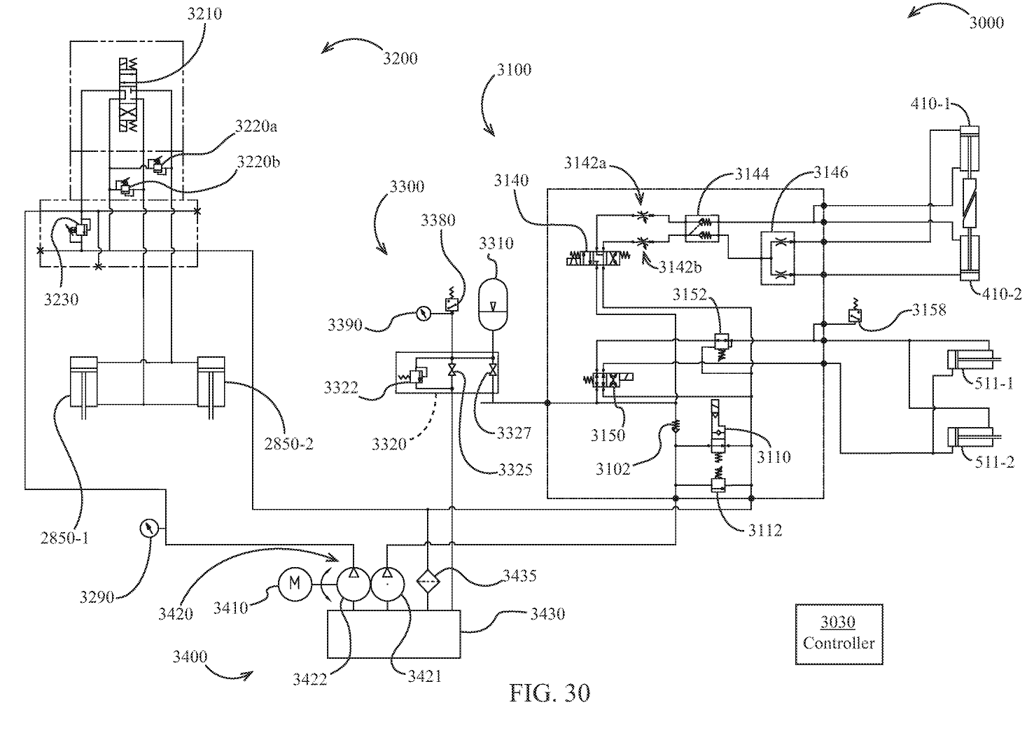

Referring to FIG. 30, an exemplary embodiment of a hydraulic control system 3000 is illustrated.

In general, the hydraulic system optionally includes a jaw crusher control system 3100 and in some embodiments additionally includes a tipping grate control system 3200. In some embodiments, the control systems 3100 and 3200 are powered by a common power unit 3400; in other embodiments, separate power units are used to individually power the control systems 3100, 3200. In some embodiments, an accumulator circuit 3300 including an accumulator 3310 accumulates pressurized hydraulic fluid for use by the control system 3100 and/or control system 3200. In some embodiments, a bypass valve 3110 changes an operating state (e.g., closes) in order to charge the accumulator 3310 under certain conditions (e.g., when the system pressure in control system 3200 is below a threshold pressure such as 3000 psi). A relief valve 3112 optionally relieves hydraulic fluid from the control system 3200 to a reservoir 3430 (e.g., via a filter 3435) when a pressure in the control system 3200 exceeds a threshold pressure (e.g., 3500 psi).

In some embodiments, the power unit 3400 includes a motor 3410 (e.g., electric motor) operably coupled to a hydraulic pump 3420. In some embodiments, the pump 3420 comprises a tandem pump (e.g., a tandem fixed-displacement pump). The pump 3420 optionally includes two outlets 3422 and 3421. The reservoir 3430 stores oil returned by various components of the control system 3000 for use by the pump 3420.

Referring to the jaw crusher control system 3100 in more detail, the outlet 3421 optionally supplies hydraulic fluid to the wedge adjustment actuators 410-1, 410-2. A directional valve 3140 is optionally in fluid communication with the actuators 410 and in data communication with a controller 3030; in response to a command from controller 3030, the directional valve 3140 (e.g., three-position valve) changes its position in order to alternately extend, retract, and retain an extension of the actuators 410. A pair of flow control valves 3142a, 3142b optionally maintain a selected flow rate in each hydraulic line in communication with the actuators 410. A pair of pilot operated check valves 3144 optionally equalizes one or more pressures in actuator 410-1 to one or more pressures in actuator 410-2. A flow divider 3146 optionally imposes an equal flow of hydraulic fluid to the actuators 410-1, 410-2.

Continuing to refer to the jaw crusher control system 3100, the outlet 3421 is optionally in fluid communication with the tensioning cylinders 511-1, 511-2. A directional valve 3150 may be used to reverse the direction of pressure applied by tensioning cylinders 511. The directional valve 3150 is optionally in data communication with controller 3030. A pressure reducing valve 3152 may be used to maintain a selectively adjustable pressure in the tensioning cylinders 511. A pressure switch 3158 is optionally in fluid communication with the tensioning cylinders 511. The pressure switch 3158 optionally sends information to the controller 3030 indicating whether the pressure in the cylinders 511 is above a selected threshold; if not, the controller 3030 optionally changes an operating state of (e.g, turns off) one or more components of the jaw crusher (e.g., motor 210, motor 3410, etc.).

Referring to the optional tipping grate control system 3200, outlet 3422 of pump 3420 is optionally in fluid communication with the grate tipping actuators 2850-1, 2850-2. A position of a directional valve 3210 may be used to alternately extend, retract, and retain an extension of the actuators 2850. A pressure reducing valve 3220a optionally maintains a first selected pressure in the head ends of the actuators 2850 (e.g., when raising the grate). A pressure reducing valve 3220b optionally maintains a second selected pressure in the rod ends of actuators 2850 (e.g., when lowering the grate). The second pressure is optionally different from (e.g., less than) the first pressure. A pressure reducing valve 3230 optionally relieves hydraulic fluid and/or pressure from the control system 3200 if the system pressure in the control system 3200 exceeds a predetermined threshold pressure (e.g., 1800 psi). A pressure gauge 3290 optionally indicates the current system pressure of the control system 3200 to an operator.

Referring to the accumulator circuit 3300, the accumulator 3310 is optionally in fluid communication with the jaw crusher control system 3100. Optional ball valves 3327, 3325 are open and closed, respectively, but may be adjusted (e.g., closed or opened) for maintenance operations. A pressure reducing valve 3322 optionally relieves the accumulator 3310 of fluid if the accumulator pressure exceeds a safety threshold (e.g., 3500 psi). In some embodiments, the ball valves 3327, 3325 and pressure reducing valve 3322 comprise an accumulator valve 3320.

In operation, while the pump 3420 is running the accumulator 3310 accumulates hydraulic fluid until a pressure switch 3380 optionally sends information to the controller 3030 indicating that the accumulator pressure meets or exceeds an upper threshold pressure (e.g., 3000 psi). Upon receiving such information, the controller 3030 optionally commands the pump 3420 to shut down. Upon further operation, as the accumulator pressure decreases below a lower threshold pressure (e.g., 1200 psi), the pressure switch 3380 optionally sends information to the controller 3030 indicating that the pressure has crossed the lower threshold. Upon receiving such information, the controller 3030 optionally commands the pump 3420 to turn on such that the accumulator begins to recharge.

In some embodiments, a bypass valve 3110 (e.g., an on-off valve such as a solenoid-operated on-off valve, normally open on-off valve, solenoid-operated normally open on-off valve, etc.) is used to selectively charge the accumulator 3310 (e.g., when a the accumulator is not charged to its upper threshold pressure and a function other than tensioning cylinders 511 is being used). In some embodiments, the controller 3030 closes the bypass valve (e.g., charges the accumulator 3310) when the actuators 2850 are being extended or retracted and the accumulator 3310 is not charged to its upper threshold pressure. In some embodiments, the controller 3030 closes the bypass valve 3110 (e.g., charges the accumulator 3310) when the wedge adjustment actuators 410 are being extended or retracted and the accumulator 3310 is not charged to its upper threshold pressure. In some embodiments, the controller 3030 closes the bypass valve when the accumulator pressure is below its lower threshold pressure.

In some embodiments, the controller 3030 opens the bypass valve 3110 when the accumulator pressure reaches a threshold pressure (e.g., 2900 psi, 3000 psi, etc.). In some embodiments, the controller 3030 opens the bypass valve 3110 when the power unit 3400 is turned off.

In some embodiments, the controller 3030 opens the bypass valve 3110 when the actuators 2850 are being extended or retracted and the accumulator 3310 is charged to its upper threshold pressure.

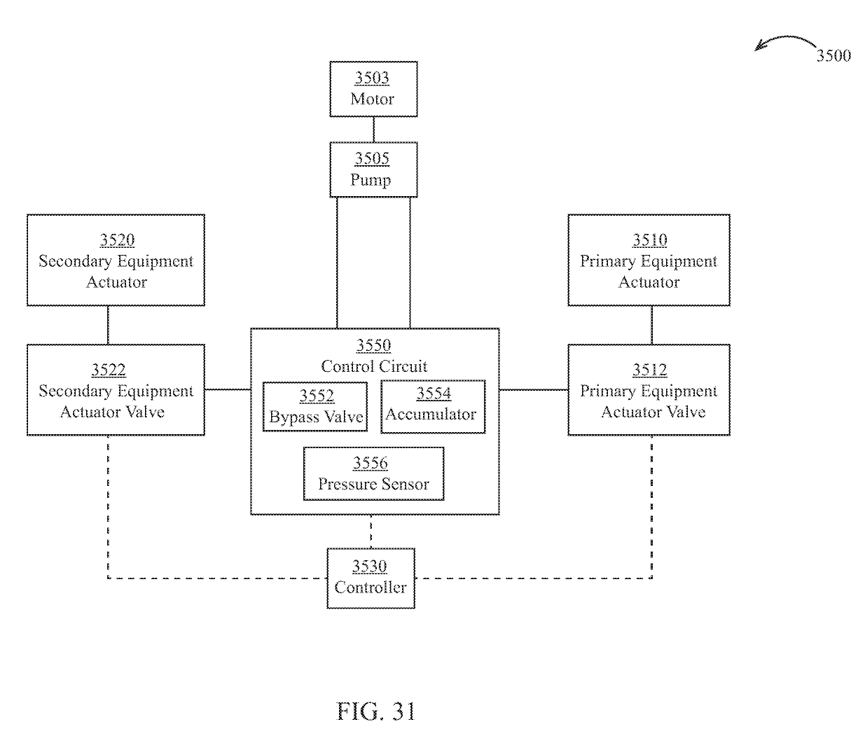

Referring to FIG. 31, another embodiment of a control system 3100 is illustrated. The control system 3100 optionally includes a motor 3503 operably coupled to a hydraulic pump 3505. The hydraulic pump 3505 is optionally in fluid communication with a control circuit 3550 (e.g., via two outlets of the pump 3505). The control circuit 3550 optionally includes a bypass valve 3552 (e.g., directional control valve), an accumulator 3554, and a pressure sensor 3556 (e.g., pressure switch, pressure transducer, etc.).

The control circuit 3550 is optionally in fluid communication with a primary equipment actuator valve 3512 (e.g., directional control valve) which optionally controls extension and/or retraction of a primary equipment actuator 3510 (e.g., an actuator incorporated in a crusher such as a jaw crusher, cone crusher, rotary impactor, etc.; or in other embodiments another unit of aggregate processing equipment).

The control circuit 3550 is optionally in fluid communication with a secondary equipment actuator valve 3522 (e.g., directional control valve) which optionally controls extension and/or retraction of a secondary equipment actuator 3520 (e.g., an actuator incorporated in a tipping grate, grizzly feeder, conveyor, or other unit of aggregate processing equipment).

A controller 3530 is optionally in data communication with the control circuit 3550 (e.g., for sending commands to the bypass valve 3552 and/or for receiving a pressure-related signal from pressure sensor 3556). The controller 3530 is optionally in data communication with the primary equipment actuator valve 3512 (e.g., for sending commands to the valve 3512). The controller is optionally in data communication with the secondary equipment actuator valve 3522 (e.g., for sending commands to the valve 3522).

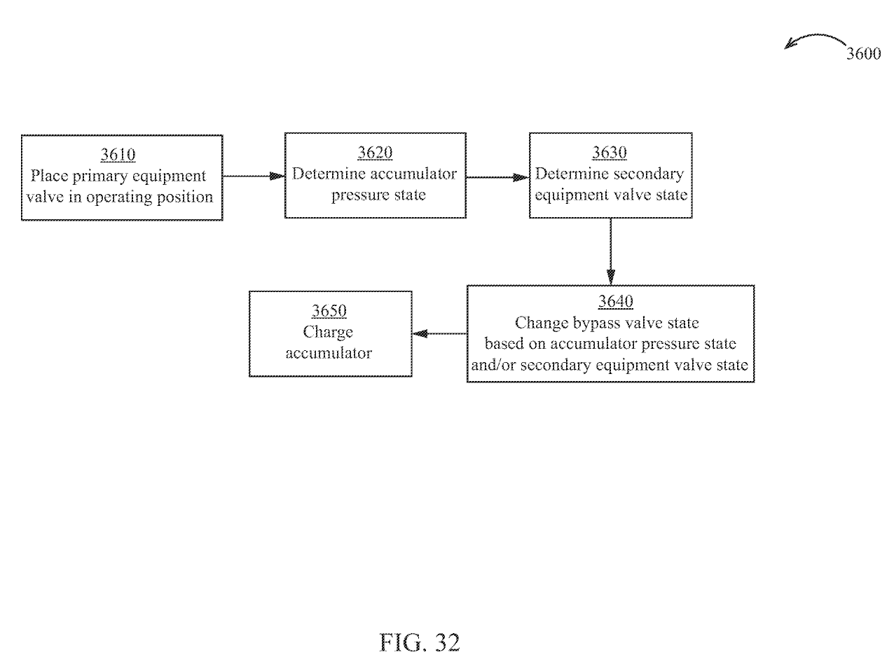

Referring to FIG. 32, an embodiment of a control method 3600 is illustrated. At step 3610, the controller 3530 optionally places the primary equipment actuator valve 3512 in an operating position (e.g., such that a primary equipment actuator such as a jaw crusher tensioning cylinder is actuated). At step 3620, the controller 3530 optionally determines the accumulator pressure state (e.g., using a pressure-related signal from the pressure sensor 3556); for example, the controller may determine whether the accumulator pressure is above or below a threshold pressure. At step 3630, the controller 3530 optionally determines a state of the secondary equipment actuator valve 3522 (e.g., determines whether an actuator such as a grate tipping actuator, conveyor lift actuator, etc. is being extended or retracted).

At step 3640, the controller 3530 optionally changes a position of (e.g., opens or closes) the bypass valve 3552. In some embodiments, the controller 3530 changes a position of the bypass valve 3552 based on an accumulator pressure state and/or the state of the secondary equipment actuator valve 3522. For example, in some embodiments if the accumulator pressure is above a first threshold pressure and the secondary equipment actuator valve 3522 is in an operating position, the bypass valve is closed. In some embodiments, if the accumulator pressure is below a second (e.g., minimum) threshold pressure, the bypass valve is closed. At step 3650, the accumulator 3554 is optionally charged (e.g., due to the modification of the state of bypass valve 3552 at step 3640).

It should be appreciated that alternative hydraulic control systems and/or control methods may be used with the various crusher embodiments described herein, and that various crusher embodiments may be used with or without secondary functions such as feeders, tipping grates. In various embodiments including secondary functions, those secondary functions may be controlled separately and/or powered by separate power units.

Ranges recited herein are intended to inclusively recite all values within the range provided in addition to the maximum and minimum range values. Headings used herein are simply for convenience of the reader and are not intended to be understood as limiting or used for any other purpose.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents.

1. A jaw crusher, comprising:
a fixed jaw;
a first jaw die mounted to said fixed jaw;
a movable jaw;
a second jaw die mounted to said movable jaw; and
a first support disposed to support said first jaw die, said support removably mounted to said fixed jaw, said support including a protrusion extending at least partially into said first jaw die, said protrusion being disposed above a lower end of said first jaw die.

2. The jaw crusher of claim 1, wherein said protrusion includes a support surface, wherein said support surface is configured to engage a surface of said first jaw die.

3. The jaw crusher of claim 2, wherein said support surface is generally upward-facing.

4. The jaw crusher of claim 2, wherein said support surface is disposed above a lower end of said first jaw die.

5. The jaw crusher of claim 2, wherein said support includes an opening, wherein said support is removably mounted to said fixed jaw by a fastener, said fastener extending at least partially through said opening, said fastener extending at least partially into said fixed jaw, wherein said opening is disposed at least partially below said support surface.

6. The jaw crusher of claim 2, wherein said support surface is disposed at an upper end of said support.

7. The jaw crusher of claim 2, wherein said support surface is upwardly angled with respect to an upper surface of said support.

8. The jaw crusher of claim 2, wherein said protrusion comprises a generally vertically extending surface.

9. The jaw crusher of claim 2, wherein said protrusion comprises a lower surface.

10. The jaw crusher of claim 1, wherein said protrusion extends at least partially into said jaw die.

11. The jaw crusher of claim 1, wherein said protrusion extends at least partially into a cavity in said jaw die.

12. The jaw crusher of claim 11, wherein said protrusion comprises a generally upward-facing upper surface.

13. The jaw crusher of claim 11, wherein said protrusion comprises a generally inward-facing surface, said inward-facing surface being disposed inside said cavity.

14. The jaw crusher of claim 11, wherein said protrusion comprises a generally downward-facing surface, said downward-facing surface being disposed at least partially inside said cavity.

15. The jaw crusher of claim 1, wherein said support further comprises a support member disposed on an opposing side of said support relative to said protrusion, said support member configured to extend at least partially into said fixed jaw.

16. The jaw crusher of claim 15, wherein said support member is disposed at least partially below said protrusion.

17. The jaw crusher of claim 1, further comprising:
a tensioning actuator operably coupled to said movable jaw;
a secondary function actuator disposed to perform a secondary function;
a secondary function valve in fluid communication with said secondary function actuator, said secondary valve being configured to selectively actuate said secondary function actuator;
a hydraulic power unit operably coupled to said tensioning actuator and said secondary actuator;
a bypass valve operably coupled to said power unit;
an accumulator;
a pressure sensor, said pressure sensor in fluid communication with said accumulator; and
a controller, said controller configured to change a state of said bypass valve based on a state of said secondary function valve and a signal generated by said pressure sensor.

18. A jaw die support configured to be removably mounted to a jaw of a jaw crusher and to support a jaw die adjacent to the jaw, the jaw die support comprising:
a rear surface;
a forward surface;
a protrusion extending from said forward surface away from said rear surface, said protrusion comprising:
an upper surface, said upper surface being disposed at an angle less than 90 degrees with respect to said forward surface;
a lower surface, said lower surface being vertically offset from said upper surface; and
an intermediate surface extending between said upper surface and said lower surface, said intermediate surface being horizontally offset from said forward surface.

19. The jaw die support of claim 18, further comprising an opening configured to receive a fastener therethrough, said opening extending from said rear surface to said forward surface, said opening being disposed below said protrusion.

20. The jaw die support of claim 18, further comprising a support member supported on said rear surface, said support member configured to extend at least partially into said jaw, said support member being disposed below said upper surface.
